(19) United States
(12) Patent Application Publication
(10) Pub. No.: US 2014/0279117 A1
(43) Pub. Date: Sep. 18, 2014

(54) SUBSCRIPTION AND MEMBERSHIP BASED CREDIT CARD PROCESSING SYSTEM

(71) Applicant: BESTMERCHANTRATES.COM, Orange, CA (US)

(72) Inventors: DANNY K. CHOI, COSTA MESA, CA (US); MELINDA A. CHOI, COSTA MESA, CA (US)

(73) Assignee: BESTMERCHANTRATES.COM, Orange, CA (US)

(21) Appl. No.: 14/211,428

(22) Filed: Mar. 14, 2014

Related U.S. Application Data
(60) Provisional application No. 61/787,798, filed on Mar. 15, 2013.

(51) Int. Cl. G06Q 20/08; G06Q 20/24

(52) U.S. Cl. CPC G06Q 20/085; G06Q 20/24
USPC 705/21

(57) ABSTRACT

A method for implementing a flat fee structure for credit card processing, which simplifies the fees charged to a merchant from an ISO. The flat rate processing fee may cover processing for a particular merchant for a specified period of time.

### CROSS-REFERENCE TO RELATED APPLICATIONS

This application claims the benefit of U.S. Provisional Application No. 61/787,798, filed Mar. 15, 2013, the contents of which are expressly incorporated herein by reference.

### STATEMENT RE: FEDERALLY SPONSORED RESEARCH/DEVELOPMENT

Not Applicable

### BACKGROUND OF THE INVENTION

1. Field of the Invention

The present disclosure relates generally to processing financial transactions, and more particularly, to a method of offering a flat fee for credit card processing over a specified period of time.

2. Description of the Related Art

Payment for goods and services is completed either by exchanging currency, or by provisioning, which involves the transfer of money from one account to another. This includes credit cards, debit cards, charge cards, personal checks, and the like. Such payment types offer different conveniences to the user. For example, credit cards may have flexible payment options with the option of maintaining a balance (subject to interest). Debit cards and checks may immediately deduct funds from an account upon payment. A charge card may be similar to credit cards in that credit is temporarily extended to the user, except that any balance must be paid off monthly. However, a common characteristic of all such payment types is the elimination of an immediate and direct exchange of cash.

There are several entities commonly associated with a conventional credit card transaction. The credit card is typically issued to a customer by a credit card association, such as VISA®, MASTERCARD®, DISCOVER®, among many others. The credit card association has a relationship with an issuing bank which provides the customer with a credit limit. The credit card bears a unique number that is tied to a customer account with the issuing bank. In addition to the card number, the card bears an expiration date and a security code, if there is one. When the customer wants to make a purchase, the customer presents the card to the merchant. The merchant then seeks authorization from the issuing bank to verify that the payer/customer has sufficient funds or credit to complete the transaction. The request for authorization is typically made over high-speed telecommunications links that are part of a credit card processing network using a credit card payment terminal or point of sale system. In this regard, the clearing bank performs the processing of the transaction. The merchant normally receives an authorization response in real-time, and can complete the transaction in a relatively short period of time. The respective accounts are not debited and credited immediately, but at predetermined intervals, the transactions, which are stored as batches, are submitted to the processor. Once the batches are settled, the payee/merchant's bank account is credited. The payer/customer's credit card account with the issuing bank is debited, and the exchange of funds is complete.

As briefly mentioned above, one significant benefit of credit cards and other forms of cashless payment is convenience, and an increasing number of account holders are using such payment methods for all but the smallest of transactions. Merchants similarly benefit, as a lesser volume of cash on the business premises reduces the likelihood of theft and robbery.

However, a common deficiency associated with credit cards, particularly for the merchants, are the fees associated with the credit cards. There is generally an Interchange and Assessment Fee set by the particular credit card association, i.e., VISA®, MASTERCARD®, DISCOVER®, which is typically a commission of 1% to 3% of the value of the transaction. In addition to the Interchange and Assessment Fee, there are Markup Fees set by the ISO to cover the processing services. The Markup Fees differ significantly from one ISO to the next by both amount, pricing model, and types of fees charged. For instance, the Markup Fee may be based as a percentage of the value of the transaction (i.e., 0.20% of total transaction amount) and/or a cost-per-item fee (i.e., 10 cents per item).

The significant variability associated with the Markup Fees from various ISOs makes it difficult to compare ISOs on the open market. For instance, the different Markup Fee price structure associated with one ISO may differ drastically from the Markup Fee price structure associated with another ISO. Thus, the merchant may often times select an ISO which may not offer the most cost effective option for that particular merchant.

In addition to the variability of the Markup Fees from one ISO to the next, the fee structure associated with most Markup Fees makes it difficult for a merchant to predict what the Markup Fees will be in the future. More specifically, the Markup Fee price structure typically relates to the amount of the sale, either on a commission basis or a per-item-cost basis. Therefore, the size of the Markup Fee generally is correlated to the size of the sale, which is typically tough to predict.

Therefore, there exists a need for an improved financial transaction processing method and system, which provides more certainty and makes it easier to compare fees and costs of one ISO with the fees and costs of another.

### BRIEF SUMMARY

In accordance with one embodiment of the present disclosure, there is contemplated a flat fee structure for credit card processing, which simplifies the fees charged to a merchant from an ISO.

The flat processing fee paid by the merchant to ISO may cover credit card processing services for a month, quarter, semi-annual period, yearly period, or some other period agreed to by the merchant and the ISO. Furthermore, the amount of the flat rate may be larger for longer periods of time and smaller for smaller periods of time.

The flat processing fee provides a level of certainty to the merchant because the merchant can anticipate what the credit card processing costs will be for that period of time. The flat processing fee also allows a merchant to easily compare two different ISOs to determine which ISO offers the most economical option to the merchant.

According to one embodiment, there is provided a method of processing credit card transactions of a merchant. The method includes the steps of receiving a flat-fee payment from an authorized merchant, wherein the flat fee is associated with unlimited processing services during a prescribed time period. The method further includes associating a point of sale terminal identifier with the authorized merchant and entering the point of sale terminal identifier associated with the authorized merchant into a central processing server. The central processing server is authorized to conduct processing services in response to processing requests received from the point of sale terminal associated with the authorized merchant.

The method may additionally include the step of receiving a processing request from the point of sale terminal associated with the authorized merchant.

The method may further include the step of instructing the central processing server to cease processing services in connection with the point of sale associated with the authorized merchant after the prescribed time period has lapsed.

The flat-fee payment may not be correlated to a sale amount.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating an exemplary environment in which one embodiment of the present disclosure may be implemented; and

FIGS. 2 and 3 area schematic views comparing different credit card programs to a program incorporating various aspects of the present invention (i.e., the SUBSCRIPTION PROGRAM″).

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present invention are directed toward creating a more straightforward fee structure for credit card processing. According to one implementation of the credit card processing system, the mark-up fee charged by the independent sales organization (ISO) would be a flat fee and would cover the credit card processing services for a particular merchant over a specified period of time. The flat fee pricing structure would provide several benefits to the merchant. One benefit would be that a daily discount merchant would be charged once during the specified time period, rather than periodically throughout that time period. Another benefit would be that it would be easier for the merchant to budget or plan credit card processing costs over that period of time rather than assuming periodic costs based on unknown sales volumes. A further benefit would be that the merchant would likely experience substantial savings on the flat fee rather than conventional mark-up fees.

Referring now to FIG. 1, there is shown a schematic view of the various entities and relationships involved in a credit card transaction. At the outset, a customer 10 initiates a transaction with a merchant 12 to purchase goods or services 14. The customer 10 provides the merchant 12 with a credit card 16 as a means of paying for the goods or services 14. As used herein, the phrase “credit card” refers to conventional credit cards as well as other cashless forms of payment. The credit card 16 is issued by an issuing bank 18 with which the customer 10 has a relationship. In essence, the customer 10 has agreed with the issuing bank 18 that any money paid to the merchant 12 through usage of the credit card 16 will be repaid to the issuing bank 18 by the customer 10.

Upon presenting the credit card 16 to the merchant 12, identification and authentication data associated with the credit card 16 is entered into a point of sale (POS) terminal 20. The identification and authentication data includes an account number 22, a card expiration date 24, and a security identifier 26. This data is typically imprinted or pressed onto the face of the credit card 16 as well as encoded in a magnetic strip disposed on the reverse side of the credit card 16. By swiping the magnetic strip through a corresponding reader on the POS terminal 20, the identification and authentication data may be read and entered without further user intervention. If the magnetic strip is unreadable, the data may be entered manually through a key pad. Along with the identification and authentication data, the amount to deduct from the account associated with the credit card 16 and transferred to the merchant 12 is entered and approval is sought by the Issuing Bank 18, to confirm to the merchant 12 that the account associated with the credit card 16 includes sufficient funds to cover the cost of the goods or services 14. This may be completed via a transaction network to which the POS terminal 20 may be connected.

At predefined intervals, each of the accumulated transactions, which may also be referred to as a “batch,” from the merchant 12 are transferred to a processor/processor server 30, which processes the transaction to transfer funds to the merchant's account through a clearing bank 32. In completing the process, the merchant 12 is charged an interchange fee 34 payable to the credit card association 28, as well as processing fees 36 and Mark Up Fees 36A from the ISO 40. As will be explained in more detail below, various aspects of the present invention are directed toward creating a flat processing fee 36 which covers processing services by the processor 30 and ISO 40 for a particular merchant 12 for a specified period of time, such as annually, monthly, or some other period of time.

At or around the time of transferring the funds to the merchant's account with the clearing bank 32, the processor 30 queries the issuing bank 18 to request a transfer from the account associated with the particular credit card 16. The issuing bank 18 maintains a record of all transactions made through the credit card 16, and sends a bill 38 to the customer 10 on a periodic basis. The customer 10 is then expected to submit payment to reimburse the issuing bank 18 per the terms of their credit card agreement.

With the general credit card transaction process being described above, the following discussion focuses on the processing fees 36 charged by the ISO 40 to the merchant 12. As alluded to above, one aspect of the present invention is to implement a flat processing fee 36 over a defined period of time. For instance, an ISO 40 may charge a merchant 12 $199 annually as the processing fee 36. Thus, once the merchant 12 pays the $199, the processor 30 processes the credit card transactions for the merchant 12 over the course of that year. Of course, the amount charged by the ISO 40 and the duration of time may be varied without departing from the spirit and scope of the present invention. For instance, the agreement between the ISO 40 and the merchant 12 may be for a monthly time period, quarterly time period, semi-annual time period, annual time period, perpetual time period, or other time periods which may be desired. Furthermore, the amount of the fee 36 may be changed depending on the agreed upon time period. For instance, an annual fee would typically be greater than a monthly fee. Although there may be some economic incentive for signing up for an annual term as opposed to a monthly term, such as a lower per month cost associated with the annual fee compared to the monthly fee.

The Table 1 below provides an example which illustrates the difference between the flat processing fees of the present invention and the variable processing fees associated with conventional credit card processing models. In the example, the merchant negotiated “interchange-plus” pricing with a provider mark-up of 0.20% (see “Disc %”) and a ten cents per item transactional fee (see “Disc P/I”). Based on the mark-up, the provider received $28.86 (see “discount due”) for the mark-up.

TABLE 1

| | Number | Amount | Number | Amount | | | | | |
|---|---|---|---|---|---|---|---|---|---|
| Plan | of | of | of | of | | Average | Disc | Disc | Discount |
| Code | Sales | Sales | Credits | Credits | Net Sales | Ticket | P/I | % | Due |
| VS | 64 | $11,228.42 | 00 | .00 | $11,228.42 | 175.44 | .100 | .200 | $28.86 |

According to the flat rate processing fee structure, the discount percent would be “0.00” or a savings of $22.46 on the above example. Rather than creating a mark-up rate on every transaction, the ISO would simply charge the merchant $199 annually in exchange for the mark-up.

Referring now, specifically to FIGS. 2 and 3, different scenarios are illustrated for purposes of highlighting the benefits associated with various aspects of the present invention. In both FIGS. 2 and 3, a hypothetical is presented wherein a small business owner processes $10,000 of debit card transactions per month. In FIG. 2, three (3) different programs are compared to illustrate the differences between discount or interchange plus rates associated with current programs and the subscription fee. The first program is a “flat rate program” which charges a flat rate of 2.75% to process the transactions. Thus, the total discount rate for processing the $10,000 of debit card transitions are $275 (i.e., 0.0275×$10,000).

The second program incorporates various aspects of the flat-rate/subscription model of the present invention, and is referred to as the “subscription program,” wherein the merchant pays a straightforward monthly fee of $20 per month to process the transactions in lieu of a Mark-Up and/or typical merchant fees such as Statement, PCI, Monthly Minimum Fees, etc. The “subscription program” also includes an example of an interchange rate of 0.22%, which is charged by the credit card companies (Visa, MasterCard, Discover). Thus, the total fees for processing the $10,000 of debit card transactions under the “subscription program” is $42 (i.e., $20 +0.0022×$10,000).

The third program is referred to as the “qualified rate program” which charges a rate of 1.59% to process the transactions. Thus, the total fees for processing the $10,000 of debit card transactions under the “qualified rate program” is $159 (i.e., 0.0159×$10,000).

Therefore, according to the situation set forth in FIG. 2, the business owner can save considerable amounts of money by using the flat subscription program. In particular, a business owner could save $117 per month compared to the qualified rate program, and $233 per month when compared to the flat rate program (savings amount may vary depending on interchange rate).

In FIG. 3, the “flat rate program” and the “qualified rate program” are the same; however, the “subscription program” is slightly different from the particulars shown in FIG. 2. In particular, the “subscription program” in FIG. 3 includes a monthly processing fee of $40, which leads to a total fee amount of $62 per month (i.e., $40+0.0022×$10,000). Thus, the business owner in the schematic set forth in FIG. 3 also saves a considerable amount of money compared to the “flat rate program” and the “qualified program.”

The “subscription program” is distinguishable from many conventional program because the subscription fee charged to the small business client by the ISO is not directly dependent upon a discount rate, interchange plus rate, or ISO mark up rate. In other words, the fee is not a percentage of the transaction amount, as is often the case in many conventional programs. In this regard, the amount of the transaction does not necessarily dictate the amount charged to the client.

Those skilled in the art will understand that the programs described above are general summaries and examples of programs and rates currently and potentially available for small businesses. In this regard, such programs may include additional fees and conditions which are not shown or described herein. For instance, additional authorization and transaction fees are commonly associated with such plans, and may be incurred for each transaction. The number and amount of the additional fees may depend on the type of transaction, the type of equipment being used (i.e., mobile unit, etc.).

The following chart offers exemplary subscription plans which may be offered to a business owner to provide several subscription levels from which to choose.

| | Monthly Fee | | | | |
|---|---|---|---|---|---|
| | $20 | $30 | $40 | $60 | $99 |
| Processing Limit | $5,000 | $10,000 | $40,000 | $80,000 | No Limit |

Those skilled in the art will readily appreciate that the fee amount and the processing limits are exemplary in nature only and are not intended to limit the scope of the present invention. In this regard, different fees may be offered in connection with differing processing limits without departing from the spirit and scope of the present invention. Along these lines, the present invention generally relates to any flat subscription fee for a certain amount of credit card processing, or in some instances, unlimited processing.

The merchant may add additional features to their processing services through the website during the application process via a value-adding checkout system. With each monthly fee a particular transactional fee is associated. During the checkout process, the merchant may choose a monthly fee or annual fee, whichever best suits their needs, by buying down their transactional fees for a higher monthly fee. For example, the advertised subscription fee may be $20 per month with each transactional fee set at $.25. The merchant with high transactional volume may choose to buy down their transactional fee to $.20 per transaction and pay $25 per month or $.15 per transaction and pay $30 per month. Additionally, the merchant may add customized features such as Authorize.Net or upgrade their terminal for an additional monthly fee. The detailed description set forth herein is not intended to represent the only options that may be offered or utilized.

It is contemplated that the business owners may be offered gifts or prizes for signing up for a subscription plan. The amount of the gift/prize may be commensurate in scope with the subscription plan the user signs up for. For instance, a user paying a monthly fee of $20/month may be offered a smaller gift or prize than a user paying $60/month. The gifts may include a basic terminal, a free iPhone/Android Reader, a free premium terminal, etc. For higher-level plans (i.e., more costly subscription plans), the gift or incentive may be a reduction in additional fees charged to the business owners.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method of processing credit card transactions of a merchant, the method comprising the steps of:
receiving a flat-fee payment from an authorized merchant, the flat fee being associated with unlimited processing services during a prescribed time period;
associating a point of sale terminal identifier with the authorized merchant;
entering the point of sale terminal identifier associated with the authorized merchant into a central processing server; and
authorizing the central processing server to conduct processing services in response to processing requests received from the point of sale terminal associated with the authorized merchant.

2. The method recited in claim 1, further comprising the step of receiving a processing request from the point of sale terminal associated with the authorized merchant.

3. The method recited in claim 1, wherein the prescribed time period is one year.

4. The method recited in claim 1, wherein the prescribed time period is six months.

5. The method recited in claim 1, wherein the prescribed time period is three months.

6. The method recited in claim 1, further comprising the step of instructing the central processing server to cease processing services in connection with the point of sale associated with the authorized merchant after the prescribed time period has lapsed.

7. The method recited in claim 1, wherein the flat-fee payment is not correlated to a sale amount.
